(19) United States
(12) Patent Application Publication
(10) Pub. No.: US 2010/0310878 A1
(43) Pub. Date: Dec. 9, 2010

(54) WASH-OUT RESISTANT HEAT-CURING EPOXY RESIN ADHESIVES

(75) Inventors: David Hofstetter, Winterthur (CH); Johann Ulrich Winteler, Baar (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/864,104

(22) PCT Filed: Jan. 30, 2009
(86) PCT No.: PCT/EP09/51084

§ 371 Date: Jul. 22, 2010

(30) Foreign Application Priority Data
Jan. 30, 2008 (EP) 08150842.6

(51) Int. Cl. B32B 27/38; C08L 63/00; C08L 77/00; C08L 75/04; B32B 37/12

(52) U.S. Cl. 428/414; 525/533; 525/423; 525/454; 156/330

(57) ABSTRACT

The present invention relates to heat-curing epoxy resin compositions, which are used in particular as body shell adhesives for vehicle construction, in that they have improved wash-out resistance, especially also at temperatures around 60° C., and the viscosity of which at room temperature enables an application at room temperature.

### TECHNICAL FIELD

The present invention relates to the field of heat-curing epoxy resin bodyshell adhesives.

### PRIOR ART

Heat-curing epoxy resin adhesives have been used for a long time as adhesives for the bodyshell of a means of transport. After application of these adhesives and joining, the joined parts are lacquered. In order to optimize the lacquering process, these parts are cleaned before lacquering using a wash liquid. In order to withstand this cleaning process and to avoid introducing impurities and contaminants in the subsequent CDC process (CDC=cathodic dip coating), the adhesive used must be as “wash-resistant” as possible.

Such adhesives in the prior art are very high-viscosity when applied at room temperature and therefore are mainly applied at high temperatures. But this is a considerable disadvantage, especially for spray application.

Epoxy resins containing polyvinyl butyrals or core/shell polymers are also used as bodyshell adhesives. However, after brief heating at a temperature of 100° C.-130° C., these adhesives exhibit low wash resistance at a temperature of about 60° C. Furthermore, the required amount of polyvinyl butyrals or core/shell polymers is very high, leading to difficulties in application or to storage stability problems.

### DESCRIPTION OF THE INVENTION

The aim of the present invention is to provide heat-curing epoxy resin compositions which can be properly applied at room temperature and, after brief heating at a temperature of 100° C. to 130° C., are also wash-resistant at higher temperatures, i.e., between 20° C. and 100° C., in particular between 40° C. and 70° C., preferably between 50° C. and 70° C.

It was surprisingly discovered that this aim can be achieved by means of a one-component heat-curing epoxy resin composition as specified in Claim 1.

Further aspects constitute a method for bonding as specified in Claim 11 as well as uses as specified in Claims 13 and 15 and a bonded article as specified in Claim 14.

Preferred embodiments of the invention are the subject matter of the subclaims.

### EMBODIMENTS OF THE INVENTION

The present invention in a first aspect relates to one-component heat-curing epoxy resin compositions which include
at least one epoxy resin A with more than one epoxy group per molecule on the average;
at least one curing agent B for epoxy resins, which is activated by elevated temperature;
at least one amide AM with melting point of 100° C. to 145° C., where the amide AM is a fatty acid amide or a polyamide.

The epoxy resin compositions contain at least one epoxy resin A with more than one epoxy group per molecule on the average. The epoxy group is preferably a glycidyl ether group. The epoxy resin A with more than one epoxy group per molecule on the average is preferably a liquid epoxy resin or a solid epoxy resin. The term “solid epoxy resin” is very familiar to the person skilled in the art of epoxides, and is used in contrast to “liquid epoxy resins.” The glass transition temperature of solid resins is above room temperature, i.e., at room temperature they can be broken up into free-flowing particles.

Preferred solid epoxy resins have formula (A-I):

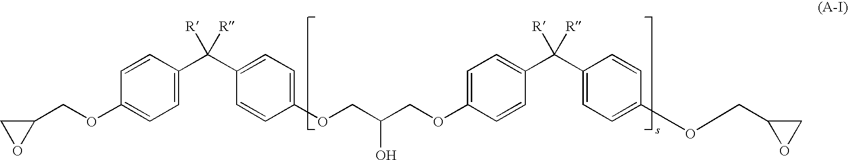

Here the substituents R′ and R″ each independently stand for either H or CH₃. The term “each independently” in the definition of groups and radicals in this document means that groups having the same designation but appearing more than once in the formulas can have different meanings in each case.

Furthermore, the subscript s stands for a number >1.5, in particular a number from 2 to 12.

Such solid epoxy resins are commercially available, for example, from Dow or Huntsman or Hexion.

Compounds of formula (A-I) with a subscript s between 1 and 1.5 are called semisolid epoxy resins by the person skilled in the art. For the present invention here, they are also considered as solid resins. However, epoxy resins in the narrower sense are preferred, i.e., for which the subscript s has a value >1.5.

Preferred liquid epoxy resins have formula (A-II):

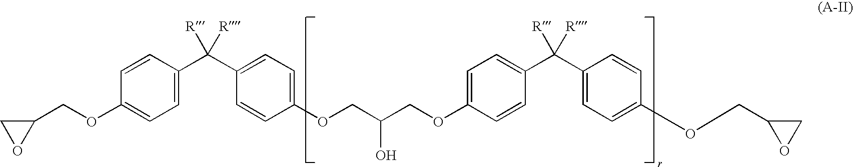

Here the substituents R′″ and R″″ each independently stand for either H or CH₃. Furthermore, the subscript r stands for a number from 0 to 1. The subscript r preferably stands for a number less than 0.2.

These compounds are therefore preferably diglycidyl ethers of bisphenol A (DGEBA), bisphenol F, and bisphenol A/F.

(The designation “A/F” here refers to a mixture of acetone and formaldehyde, which is used as a starting material in its manufacture.) Such liquid resins are available, for example, as Araldite GY 250, Araldite PY 304, Araldite® GY 282 (Huntsman, or Hexion), or D.E.R.™331 or D.E.R.™330 (Dow) or Epikote 828 (Hexion).

Epoxy resin A preferably represents a liquid epoxy resin of formula (A-II). In another even more preferred embodiment, the heat-curing epoxy resin composition contains at least one liquid epoxy resin of formula (A-II) as well as at least one solid epoxy resin of formula (A-I).

The proportion of epoxy resin A is preferably 10-85 wt. %, in particular 15-70 wt. %, preferably 15-60 wt. %, based on the weight of the composition.

The heat-curing epoxy resin composition contains at least one curing agent B for epoxy resins, which is activated by elevated temperature. Here the curing agent is preferably selected from the group consisting of dicyanodiamide, guanamines, guanidines, aminoguanidines, and derivatives thereof. Catalytically effective curing agents can also be used, such as substituted ureas such as, for example, 3-(3-chloro-4-methylphenyl)-1,1-dimethylurea (chlortoluron) or phenyl dimethylureas, in particular p-chlorophenyl-N,N-dimethylurea (monuron), 3-phenyl-1,1-dimethylurea (fenuron), or 3,4-dichlorophenyl-N,N-dimethylurea (diuron). Compounds in the imidazole class, such as 2-isopropylimidazole or 2-hydroxy-N-(2-(2-(2-hydroxyphenyl)-4,5-dihydroimidazol-1-yl)ethyl)benzamide, and amine complexes can also be used.

Curing agent B is preferably a curing agent selected from the group consisting of dicyanodiamide, guanamines, guanidines, aminoguanidines, and derivatives thereof; substituted ureas, in particular 3-(3-chloro-4-methylphenyl)-1,1-dimethylurea (chlortoluron), or phenyl dimethylureas, in particular p-chlorophenyl-N,N-dimethylurea (monuron), 3-phenyl-1,1-dimethylurea (fenuron), 3,4-dichlorophenyl-N,N-dimethylurea (diuron), as well as imidazoles and amine complexes.

Dicyanodiamide is particularly preferred as curing agent B.

The amount of curing agent B for epoxy resins, which is activated by elevated temperature, is advantageously 0.1-30 wt.-%, in particular 0.2-10 wt.-%, based on the weight of epoxy resin A.

The heat-curing epoxy resin composition contains at least one amide AM with melting point of 100° C. to 145° C. This amide AM is a fatty acid amide or a polyamide.

In this document, the prefix “poly” [used] in this invention in substance names such as, for example, “polyamide”, “polyol”, “polyamine, “polyphenol”, or “polyisocyanate”, means substances that formally contain two or more of the functional groups appearing in their name per molecule.

The amide AM preferably has a melting point of 120° C. to 130° C.

In one embodiment, the amide AM is a fatty acid amide. The fatty acid amide can be in particular fatty amines of formula (II).

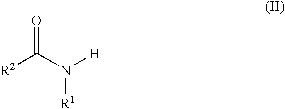

Here R¹ stands for H or a C₁-C₄ alkyl group or a benzyl group, and R² stands for a saturated or unsaturated C₈-C₂₂ alkyl group.

The amide of formula (II) is especially an amide selected from the group consisting of lauric, myristic, palmitic, stearic, and linolenic acid amide.

In a further embodiment, the amide AM is a polyamide. A polyamide wax is especially preferred as the polyamide.

Especially preferred amides AM are such polyamides as are commercially marketed under the series trade names Disparlon® by Kusumoto Chemicals Ltd., Japan or Luvotix® by Lehmann & Voss & Co., Germany.

It is also quite possible to use mixtures of two or more amides AM in the composition.

The weight percent of all amides AM in the composition is advantageously 0.1-5.0 wt. %, in particular 0.2-4.0 wt. %, preferably 0.5-3.0 wt. %.

The heat-curing epoxy resin composition advantageously contains at least one toughener D.

“Toughener” in this document means an additive to an epoxy resin matrix that, even for small additions of 0.1-50 wt. %, in particular 0.5-40 wt. %, causes a definite increase in toughness, and thus higher bending, tensile, shock, or impact stresses can be withstood before the matrix cracks or breaks.

The toughener D can be either a solid or liquid toughener.

Solid tougheners are, in a first embodiment, organic ion-exchanged layered minerals. Such tougheners are described, for example, in U.S. Pat. No. 5,707,439 or U.S. Pat. No. 6,197,849.

Such solid tougheners that are especially suitable are familiar to the person skilled in the art under the term organoclay or nanoclay, and are commercially available, for example, under the group names Tixogel® or Nanofil® (Siidchemie), Cloisite® (Southern Clay Products), or Nanomer® (Nanocor, Inc.), or Garamite® (Southern Clay Products).

Solid tougheners, in a second embodiment, are block copolymers. The block copolymer, for example, is obtained from an anionic or controlled free-radical polymerization of methacrylic acid ester with at least one other monomer having an olefinic double bond. Particularly preferred as a monomer having an olefinic double bond is one in which the double bond is conjugated directly with a hetero atom or with at least one other double bond. Particularly suitable monomers are selected from the group including styrene, butadiene, acrylonitrile, and vinyl acetate. Acrylate/styrene/acrylic acid (ASA) copolymers, available, for example, under the name GELOY 1020 from GE Plastics, are preferred.

Especially preferred block copolymers are block copolymers derived from methacrylic acid methyl ester, styrene, and butadiene. Such block copolymers are available, for example, as triblock copolymers under the group name SBM from Arkema.

Solid tougheners are, in a third embodiment, core/shell polymers. Core/shell polymers consist of an elastic core polymer and a rigid shell polymer. Particularly suitable core/shell polymers consist of a core made from elastic acrylate or butadiene polymer which is enclosed in a rigid shell made from a rigid thermoplastic polymer. This core/shell structure is either formed spontaneously through separation of a block copolymer or is determined by latex polymerization or suspension polymerization followed by grafting. Preferred core/shell polymers are “MBS polymers,” which are available under the trade names Clearstrength™ from Atofina, Paraloid™ from Rohm and Haas, or F-351™ from Zeon.

Especially preferred are core/shell polymer particles that are already in the form of dried polymer latex. Examples are GENIOPERL M23A from Wacker with a polysiloxane core and an acrylate shell, radiation crosslinked rubber particles of the NEP series manufactured by Eliokem, or Nanoprene from Lanxess, or Paraloid EXIL from Rohm and Haas.

Other comparable examples of core/shell polymers are sold under the name Albidur™ by Nanoresins AG, Germany.

Solid tougheners are, in a fourth embodiment, solid reaction products of a carboxylated solid nitrile rubber and excess epoxy resin.

Liquid tougheners are preferably liquid rubbers or liquid tougheners based on a polyurethane polymer.

In a first embodiment, the liquid rubber is an acrylonitrile/butadiene copolymer terminated by carboxyl groups or (meth)acrylate groups or epoxy groups, or is a derivative thereof.

Such liquid rubbers are commercially available, for example, under the name Hypro™ (formerly Hycar®) CTBN and CTBNX and ETBN from Nanoresins AG, Germany or Emerald Performance Materials LLC. Suitable derivatives are in particular elastomer-modified polymers having epoxy groups, such as are commercially marketed as the Polydis® product line, preferably from the Polydis® 36xx product line, by the Struktol Company (Schill & Seilacher Group, Germany) or as the Albipox product line (Nanoresins, Germany).

In a second embodiment, this liquid rubber is a polyacrylate liquid rubber that is completely miscible with liquid epoxy resins, and only separates into microdroplets during curing of the epoxy resin matrix. Such polyacrylate liquid rubbers are available, for example, under the name 20208-XPA from Rohm and Haas.

In a third embodiment, this liquid rubber is a polyether amide terminated by carboxyl groups or epoxy groups. Such polyamides are in particular synthesized from reaction of amino-terminated polyethylene ethers or polypropylene ethers, such as are marketed, for example, under the name Jeffamine® by Huntsman, or Hexion, with dicarboxylic acid anhydride, followed by reaction with epoxy resins, as described in Example 15 in conjunction with Example 13 of DE 2123033. Hydroxybenzoic acid or hydroxybenzoates can be used instead of dicarboxylic acid anhydride.

It is clear to the person skilled in the art that mixtures of liquid rubbers can of course be used, in particular mixtures of carboxyl-terminated or epoxy-terminated acrylonitrile/butadiene copolymers or derivatives thereof.

The toughener D is preferably selected from the group consisting of blocked polyurethane polymers, liquid rubbers, epoxy resin-modified liquid rubbers, and core/shell polymers.

In a preferred embodiment, the toughener D is a blocked polyurethane polymer of formula (I).

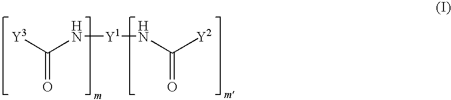

Here m and m′ each stand for numbers between 0 and 8, provided that m+m′ stands for a number from 2 to 8.

Furthermore, Y¹ stands for a linear or branched polyurethane polymer PU1 terminated by m+m′ isocyanate groups, after removal of all terminal isocyanate groups.

Y² each independently stands for a blocking group which is cleaved at a temperature above 100° C.

Y³ each independently stands for a group of formula (I′).

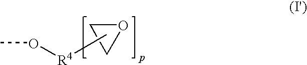

Here R⁴ in turn stands for an aliphatic, cycloaliphatic, aromatic, or araliphatic epoxy radical containing a primary or secondary hydroxyl group, after removal of the hydroxy and epoxy groups, and p stands for the numbers 1, 2, or 3.

In this document, “araliphatic radical” means an aralkyl group, i.e., an alkyl group substituted by aryl groups (see Römpp, CD Römpp Chemie Lexikon [Römpp Chemistry Encyclopedia], Version 1, Stuttgart/New York, Georg Thieme Verlag 1995).

Y² each independently stands in particular for substituents selected from the group consisting of

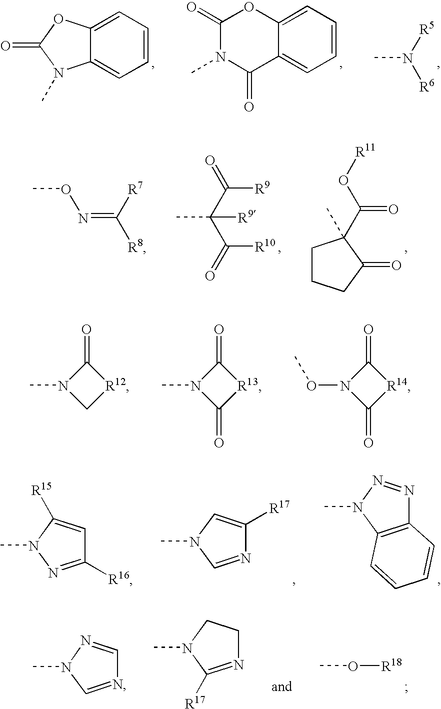

Here R⁵, R⁶, R⁷, and R⁸ each independently stand for an alkyl or cycloalkyl or aralkyl or arylalkyl group, or else R⁵ together with R⁶ or R⁷ together with R⁸ forms part of a 4- to 7-membered ring, which is substituted if needed.

Furthermore, R⁹, R^{9′}, and R¹⁰ each independently stands for an alkyl or aralkyl or arylalkyl group or for an alkyloxy or aryloxy or aralkyloxy group, and R¹¹ stands for an alkyl group.

R¹³ and R¹⁴ each stand independently for an alkylene group with 2 to 5 C atoms, which optionally has double bonds or is substituted, or for a phenylene group or for a hydrogenated phenylene group, and R¹⁵, R¹⁶, and R¹⁷ each independently stand for H or for an alkyl group or for an aryl group or an aralkyl group.

Finally, R¹⁸ stands for an aralkyl group or for a mononuclear or polynuclear substituted or unsubstituted aromatic group, which optionally has aromatic hydroxyl groups.

The dashed lines in the formulas in this document in each case represent bonding between the respective substituents and the corresponding molecular moiety.

Phenols or bisphenols, after removal of an hydroxyl group, are in particular firstly considered as R¹⁸. Preferred examples of such phenols and bisphenols are in particular phenol, cresol, resorcinol, pyrocatechol, cardanol (3-pentadecenylphenol (from cashew nutshell oil)), nonylphenol, phenols reacted with styrene or dicyclopentadiene, bisphenol-A, bisphenol-F, and 2,2′-diallyl bisphenol-A.

Hydroxybenzyl alcohol and benzyl alcohol, after removal of an hydroxyl group, are in particular secondly considered as R¹⁸.

If R⁵, R⁶, R⁷, R⁸, R⁹, R^{9′}, R¹⁰, R¹¹, R¹⁵, R¹⁶ or R¹⁷ stands for an alkyl group, the latter is in particular a linear or branched C₁-C₂₀ alkyl group.

If R⁵, R⁶, R⁷, R⁸, R⁹, R^{9′}, R¹⁰, R¹⁵, R¹⁶, R¹⁷, R¹⁸ stands for an aralkyl group, the latter group is in particular an aromatic group bonded through methylene, in particular a benzyl group.

If R⁵, R⁶, R⁷, R⁸, R⁹, R^{9′}, or R¹⁰ stands for an alkylaryl group, the latter group is in particular a C₁ to C₂₀ alkyl group bonded through phenylene such as, for example, tolyl or xylyl.

Especially preferred radicals Y² are radicals selected from the group consisting of

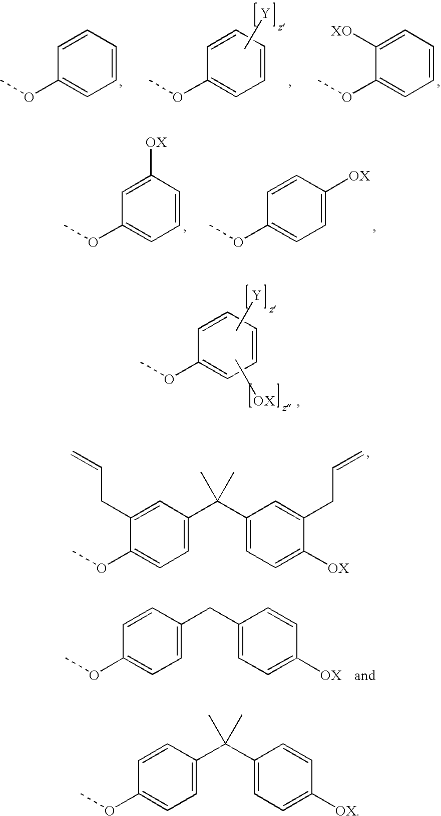

The radical Y here stands for a saturated or olefinic unsaturated hydrocarbon radical with 1 to 20 C atoms, in particular with 1 to 15 C atoms. Allyl, methyl, nonyl, dodecyl or an unsaturated C₁₅ alkyl radical with 1 to 3 double bonds are particularly preferred.

The radical X stands for H or for an alkyl, aryl, aralkyl group, in particular for H or methyl.

The subscripts z′ and z″ stand for the numbers 0, 1, 2, 3, 4, or 5, provided that the sum z′+z″ stands for a number between 1 and 5.

The blocked polyurethane polymer of formula (I) is synthesized from reaction between isocyanate group-terminated linear or branched polyurethane polymers PU1 and one or more isocyanate-reactive compounds Y²H and/or Y³H.

If more than one such isocyanate-reactive compound is used, the reaction can be carried out sequentially or with a mixture of these compounds.

The reaction is carried out in such a way that the one or more isocyanate-reactive compounds Y²H and/or Y³H are used in stoichiometric amounts or in stoichiometric excess, in order to ensure that all the NCO groups are reacted.

The isocyanate-reactive compound Y³H is a monohydroxyl epoxy compound of formula (IIIa).

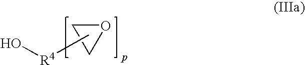

If more than one such monohydroxyl epoxy compound is used, the reaction can be carried out sequentially or with a mixture of these compounds.

The monohydroxyl epoxy compound of formula (IIIa) has 1, 2, or 3 epoxy groups. The hydroxyl group of this monohydroxyl epoxy compound (IIIa) can represent a primary or a secondary hydroxyl group.

Such monohydroxyl epoxy compounds can, for example, be produced by reaction of polyols with epichlorohydrin. Depending on how the reaction is carried out, when polyfunctional alcohols are reacted with epichlorohydrin, the corresponding monohydroxyl epoxy compounds are also formed as byproducts in different concentrations. The latter can be isolated by means of conventional separation operations. Generally, however, it is sufficient to use the product mixture obtained in the polyol glycidylization reaction, consisting of the polyol reacted completely and partially to form the glycidyl ether. Examples of such hydroxyl-containing epoxides are butanediol monoglycidyl ethers (present in butanediol diglycidyl ethers), hexanediol monoglycidyl ethers (present in hexanediol diglycidyl ethers), cyclohexanedimethanol glycidyl ethers, trimethylolpropane diglycidyl ethers (present as a mixture in trimethylolpropane triglycidyl ethers), glycerol diglycidyl ethers (present as a mixture in glycerol triglycidyl ethers), pentaerythritol triglycidyl ethers (present as a mixture in pentaerythritol tetraglycidyl ethers).

It is preferable to use trimethylolpropane diglycidyl ether, which occurs in a relatively high proportion in conventionally synthesized trimethylolpropane triglycidyl ether.

However, other similar hydroxyl-containing epoxides can also be used, in particular glycidol, 3-glycidyloxybenzyl alcohol, or hydroxymethyl cyclohexene oxide. Also preferred is the β-hydroxy ether of formula (IIIb), which is present in a proportion up to 15% in commercially available liquid epoxy resins, synthesized from bisphenol-A (R═CH₃) and epichlorohydrin, as well as the corresponding β-hydroxy ethers of formula (IIIb), which are formed when bisphenol-F (R═H) or the mixture of bisphenol-A and bisphenol-F is reacted with epichlorohydrin.

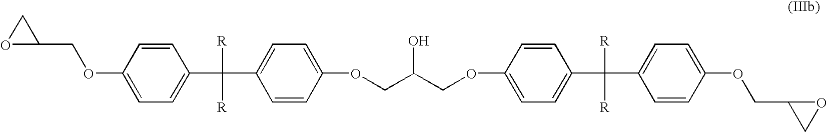

Also preferred are distillation residues produced during manufacture of high-purity distilled liquid epoxy resins. Such distillation residues have an hydroxyl-containing epoxide concentration one to three times higher than in commercially available undistilled liquid epoxy resins. Furthermore, very different epoxides with a β-hydroxy ether group, synthesized by reaction of (poly)epoxides with a substoichiometric amount of monofunctional nucleophiles such as carboxylic acids, phenols, thiols, or secondary amines, can also be used.

A trivalent radical of the following formula is particularly preferred as the radical R⁴:

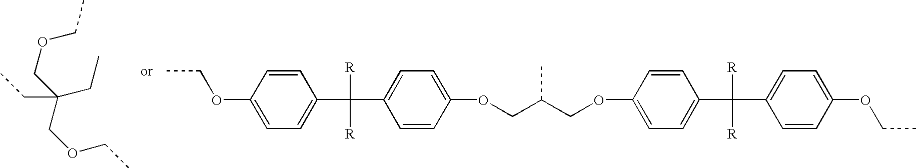

where R stands for methyl or H.

The free primary or secondary OH functional group of the monohydroxyl epoxy compound of formula (IIIa) allows for efficient reaction with terminal isocyanate groups of polymers without needing to use unusual excesses of the epoxy component.

The polyurethane polymer PU1 on which Y¹ is based can be synthesized from at least one diisocyanate or triisocyanate and at least one polymer Q_{PM} having terminal amino, thiol, or hydroxyl groups and/or one optionally substituted polyphenol Q_{PP}.

Suitable diisocyanates are, for example, aliphatic, cycloaliphatic, aromatic, or araliphatic diisocyanates, in particular commercially available products such as methylene diphenyl diisocyanate (MDI), 1,4-butane diisocyanate, hexamethylene diisocyanate (HDI), toluene diisocyanate (TDI), tolidine diisocyanate (TODD, isophorone diisocyanate (IPDI), trimethyl hexamethylene diisocyanate (TMDI), 2,5- or 2,6-bis(isocyanatomethyl)bicyclo[2.2.1]heptane, 1,5-naphthalene diisocyanate (NDI), dicyclohexylmethyl diisocyanate (H₁₂MDI), p-phenylene diisocyanate (PPDI), or m-tetramethylxylylene diisocyanate (TMXDI) as well as dimers thereof. HDI, IPDI, MDI, or TDI are preferred.

Suitable triisocyanates are, for example, trimers or biurets of aliphatic, cycloaliphatic, aromatic, or araliphatic diisocyanates, in particular the isocyanurates and biurets of the diisocyanates described in the previous paragraph.

Of course, suitable mixtures of diisocyanates or triisocyanates can also be used.

Suitable polymers Q_{PM} having terminal amino, thiol, or hydroxyl groups are in particular polymers Q_{PM} having two or three terminal amino, thiol, or hydroxyl groups.

The polymers Q_{PM} advantageously have a weight per equivalent of 300-6000, in particular 600-4000, preferably 700-2200 g/equivalent of NCO-reactive groups.

Suitable polymers Q_{PM} are polyols, for example, the following commercially available polyols or any mixtures thereof:
Polyoxyalkylene polyols, also called polyether polyols, which are the polymerization product of ethylene oxide, 1,2-propylene oxide, oxetane, 1,2- or 2,3-butylene oxide, tetrahydrofuran or mixtures thereof, optionally polymerized using an initiator molecule having two or three active H atoms such as, for example, water or compounds having two or three OH groups. Polyoxyalkylene polyols can be used that have a low degree of unsaturation (measured according to ASTM D-2849-69 and expressed in milliequivalents of unsaturation per gram polyol (meq/g)), synthesized for example using “double metal cyanide complex catalysts” (DMC catalysts for short), as well as polyoxyalkylene polyols with a higher degree of unsaturation, synthesized for example using anionic catalysts such as NaOH, KOH, or alkali metal alkoxides. Polyoxypropylene diols and triols are especially suitable which have a degree of unsaturation below 0.02 meq/g and a molecular weight in the range from 1000 to 30 000 daltons, polyoxybutylene diols and triols, polyoxypropylene diols and triols with a molecular weight from 400 to 8000 daltons, as well as “EO-endcapped” (ethylene oxide-endcapped) polyoxypropylene dials or triols. The latter are special polyoxypropylene polyoxyethylene polyols that, for example, can be obtained by alkoxylating pure polyoxypropylene polyols with ethylene oxide, after completion of polypropoxylation, and thus have primary hydroxyl groups.
Hydroxy-terminated polybutadiene polyols such as, for example, those that can be synthesized by polymerization of 1,3-butadiene and allyl alcohol or by oxidation of polybutadiene, as well as their hydrogenation products;
Styrene/acrylonitrile-grafted polyether polyols, such as supplied, for example, by Elastogran under the name Lupranol®;
Polyhydroxy-terminated acrylonitrile/butadiene copolymers, such as can be synthesized, for example, from carboxyl-terminated acrylonitrile/butadiene copolymers (commercially available under the name Hypro™ (formerly Hycar®) CTBN and CTBNX and ETBN from Nanoresins AG, Germany, or Emerald Performance Materials LLC) and epoxides or amino alcohols.
Polyester polyols, synthesized for example from dihydric or trihydric alcohols such as, for example, 1,2-ethanediol, diethylene glycol, 1,2-propanediol, dipropylene glycol, 1,4-butanediol, 1,5-pentanedial, 1,6-hexanediol, neopentyl glycol, glycerol, 1,1,1-trimethylolpropane or mixtures of the aforementioned alcohols, reacted with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the aforementioned acids, as well as polyester polyols derived from lactones such as, for example, ε-caprolactone;
Polycarbonate polyols, as can be obtained, for example, by reaction of the above-indicated alcohols (used to synthesize the polyester polyols) with dialkyl carbonates, diaryl carbonates, or phosgene.

The polymers Q_{PM} are advantageously diols or higher-functional polyols with weights per OH equivalent of 300 to 6000 g/OH equivalent, in particular from 600 to 4000 g/OH equivalent, preferably 700-2200 g/OH equivalent. Also advantageous are polyols selected from the group consisting of polyethylene glycols, polypropylene glycols, polyethylene glycol/polypropylene glycol block copolymers, polybutylene glycols, hydroxyl-terminated polybutadienes, hydroxyl-terminated butadiene/acrylonitrile copolymers, hydroxyl-terminated synthetic rubbers, their hydrogenation products and mixtures of the aforementioned polyols.

Furthermore, polymers Q_{PM} can also be used that are difunctional or higher-functional amino-terminated polyethylene ethers, polypropylene ethers such as are commercially marketed, for example, under the name Jeffamine® by Huntsman, or Hexion, polybutylene ethers, polybutadienes, butadiene/acrylonitrile copolymers such as are marketed, for example, under the name Hypro™ (formerly Hycar®) ATBN from Nanoresins AG, Germany, or Emerald Performance Materials LLC, as well as other amino-terminated synthetic rubbers or mixtures of the indicated components.

For certain applications, suitable polymers Q_{PM} are in particular hydroxyl group-containing polybutadienes or polyisoprenes or their partially or completely hydrogenated reaction products.

The polymers Q_{PM} can furthermore also undergo chain extension, such as can be done, by a method familiar to the person skilled in the art, by means of reaction of polyamines, polyols, and polyisocyanates, in particular diamines, diols, and diisocyanates.

For the example of a diisocyanate and a diol, as shown below, they form a species of formula (A) or (B), depending on the chosen stoichiometry:

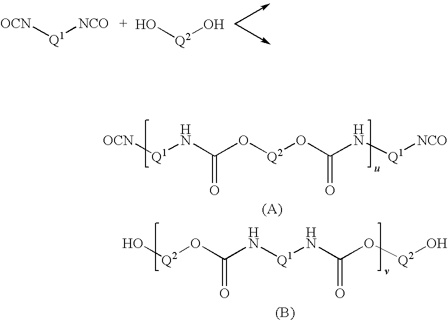

The moieties Q¹ and Q² represent a divalent organic moiety and the subscripts u and v vary from 1 to typically 5, depending on the stoichiometric ratio.

These species of formula (A) or (B) can then again be reacted further. Thus, for example, a chain-extended polyurethane polymer PU1 of the following formula can be formed from the species of formula (A) and a diol having a divalent organic moiety Q³:

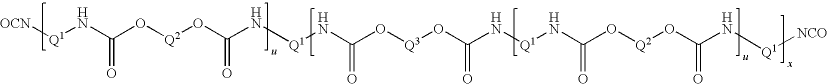

A chain-extended polyurethane polymer PU1 of the following formula can be formed from the species of formula (B) and a diisocyanate having a divalent organic moiety Q⁴:

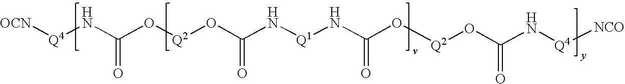

The subscripts x and y vary from 1 to typically 5, depending on the stoichiometric ratio, and are in particular 1 or 2.

The species of formula (A) can also be additionally reacted with the species of formula (B), thus forming an NCO group-containing, chain-extended polyurethane polymer PU1.

Diols and/or diamines and diisocyanates are preferred for extending the chain. Of course, it is clear to the person skilled in the art that higher-functional polyols such as, for example trimethylolpropane or pentaerythritol, or higher-functional polyisocyanates, such as isocyanurates of diisocyanates, can also be used for extending the chain.

For polyurethane polymers PU1 in general and for chain-extended polyurethane polymers in particular, it is advantageous to make sure that the polymers do not have too high a viscosity, in particular if higher-functional compounds are used for extending the chain, because this can make either their reaction to form polymers of formula (I) or application of the composition more difficult.

Preferred polymers Q_{PM} are polyols with molecular weights between 600 and 6000 daltons, selected from the group consisting of polyethylene glycols, polypropylene glycols, polyethylene glycol/polypropylene glycol block polymers, polybutylene glycols, hydroxyl-terminated polybutadienes, hydroxyl-terminated butadiene/acrylonitrile copolymers as well as mixtures thereof.

Particularly preferred polymers Q_{PM} are α,ω-dihydroxy polyalkylene glycols having C₂-C₆ alkylene groups or having mixed C₂-C₆ alkylene groups that are terminated by amino, thiol, or preferably hydroxyl groups. Polypropylene glycols or polybutylene glycols are especially preferred. Hydroxyl group-terminated polyoxybutylenes are also especially preferred.

Particularly suitable as polyphenol Q_{PP} are bisphenols, trisphenols, and tetraphenols. This means not only pure phenols but optionally also substituted phenols. The nature of the substitution can be quite diverse. In particular, this means a direct substitution on the aromatic ring to which the phenol OH group is bonded. By phenols is meant not only mononuclear aromatics but also polynuclear or condensed aromatics or heteroarornatics, which have phenol OH groups directly on the aromatic or heteroaromatic rings.

The reaction with isocyanates required to form the polyurethane polymer PU1 is affected inter alia by the nature and position of such substituents.

Bisphenols and trisphenols are especially suitable. For example, suitable bisphenols or trisphenols are 1,4-dihydroxybenzene, 1,3-dihydroxybenzene, 1,2-dihydroxybenzene, 1,3-dihydroxytoluene, 3,5-dihydroxybenzoates, 2,2-bis(4-hydroxyphenyl)propane (=bisphenol-A), bis(4-hydroxyphenyl)methane (=bisphenol-F), bis(4-hydroxyphenyl)sulfone (=bisphenol-S), naphthoresorcinol, dihydroxynaphthalene, dihydroxyanthraquinone, dihydroxybiphenyl, 3,3-bis(p-hydroxyphenyl)phthalide, 5,5-bis(4-hydroxyphenyl)hexahydro-4,7-methanoindane, phenolphthalein, fluorescein, 4,4′-[bis(hydroxyphenyl)-1,3-phenylenebis(1-methylethylidene)] (=bisphenol-M), 4,4′-bis(hydroxyphenyl)-1,4-phenylenebis(1-methylethylidene)] (=bisphenol-P), 2,2′-diallyl bisphenol-A, diphenols and dicresols synthesized by reacting phenols or cresols with diisopropylidene benzene, phloroglucinol, gallic acid esters, phenol or cresol novolacs with number of OH functional groups ranging from 2.0 to 3.5, as well as all isomers of the aforementioned compounds.

Preferred diphenols and dicresols, synthesized by reaction of phenols or cresols with diisopropylidene benzene, have a chemical structural formula as accordingly shown below for cresol as an example:

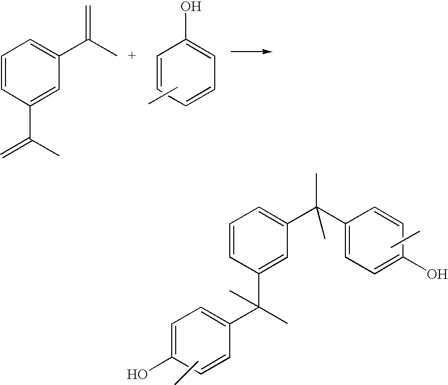

Low-volatility bisphenols are especially preferred. Bisphenol-M, bisphenol-S, and 2,2′-diallyl bisphenol-A are considered as most preferred.

Q_{PP} preferably has 2 or 3 phenol groups.

In a first embodiment, the polyurethane polymer PU1 is synthesized from at least one diisocyanate or triisocyanate and one polymer Q_{PM} having terminal amino, thiol, or hydroxyl groups. The polyurethane polymer PU1 is synthesized by a method familiar to the person skilled in the art of polyurethanes, in particular by using the diisocyanate or triisocyanate in stoichiometric excess relative to the amino, thiol, or hydroxyl groups of the polymer Q_{PM}.

In a second embodiment, the polyurethane polymer PU1 is synthesized from at least one diisocyanate or triisocyanate and at least one optionally substituted polyphenol Q_{PP}. The polyurethane polymer PU1 is synthesized by a method familiar to the person skilled in the art of polyurethanes, in particular by using the diisocyanate or triisocyanate in stoichiometric excess relative to the phenol groups of the polyphenol Q_{PP}.

In a third embodiment, the polyurethane polymer PU1 is synthesized from at least one diisocyanate or triisocyanate and one polymer Q_{PM} having terminal amino, thiol, or hydroxyl groups and one optionally substituted polyphenol Q_{PP}. Different options are available for synthesis of the polyurethane polymer PU1 from at least one diisocyanate or triisocyanate and one polymer Q_{PM} having terminal amino, thiol, or hydroxyl groups and/or one optionally substituted polyphenol Q_{PP}.

In a first method, called the “one-pot method,” a mixture of at least one polyphenol Q_{PP} and at least one polymer Q_{PM} is reacted with at least one diisocyanate or triisocyanate, using excess isocyanate.

In a second method, called “2-step method I,” at least one polyphenol Q_{PP} is reacted with at least one diisocyanate or triisocyanate, using excess isocyanate, and then reacted with at least one polymer Q_{PM} in a substoichiometric amount.

In the third method, called “2-step method II,” at least one polymer Q_{PM} is reacted with at least one diisocyanate or triisocyanate, using excess isocyanate, and then reacted with at least one polyphenol Q_{PP} in a substoichiometric amount.

The three methods lead to isocyanate-terminated polyurethane polymers PU1, which can differ in the sequence of their components while having the same composition. All three methods are suitable, but “2-step method II” is preferred.

If the described isocyanate-terminated polyurethane polymers PU1 are composed of difunctional components, it has been shown that the polymer Q_{PM}/polyphenol Q_{PP} equivalents ratio is greater than 1.50, and the polyisocyanate/(polyphenol Q_{PP}+polymer Q_{PM}) equivalents ratio is preferably greater than 1.20.

If the average number of functional groups for the components used is greater than 2, then the molecular weight increases faster than in the purely difunctional case. For the person skilled in the art, it is clear that the limits for the possible equivalents ratios depend considerably on whether or not the selected polymer Q_{PM}, the polyphenol Q_{PP}, the polyisocyanate, or more than one of the indicated components have a number of functional groups >2. Different equivalents ratios can be set depending on the circumstances; their limits are determined by the viscosity of the resulting polymers and must be experimentally determined in each case.

The polyurethane polymer PU1 preferably is elastic in nature and has a glass transition temperature Tg belown 0° C.

The end-blocked polyurethane polymer of formula (I) advantageously is elastic in nature and is furthermore advantageously soluble or dispersible in liquid epoxy resins.

Subscripts m in Formula (I) different from 0 are especially preferred.

More than one toughener D simultaneously as components of the heat-curing epoxy resin composition are especially preferred. The heat-curing epoxy resin composition especially preferably contains a blocked polyurethane polymer of formula (I) as well as at least one core/shell polymer and/or an acrylonitrile/butadiene copolymer terminated by a carboxyl or (meth)acrylate or epoxy group, or a derivative thereof.

The proportion of toughener D is preferably 0.1-50 wt. %, in particular 0.5-30 wt. %, based on the weight of the composition.

The one-component heat-curing epoxy resin composition also preferably contains in addition at least one filler F. Here the filler is preferably carbon black, mica, talc, kaolin, wollastonite, feldspar, syenite, chlorite, bentonite, montmorillonite, calcium carbonate (precipitated or ground), dolomite, quartz, silicic acids (pyrogenic or precipitated), cristobalite, calcium oxide, aluminum hydroxide, magnesium oxide, hollow ceramic spheres, hollow glass spheres, hollow organic spheres, glass spheres, colored pigments. As the filler F, we mean both organic coated and uncoated commercially available forms familiar to the person skilled in the art.

The total proportion of total filler F is advantageously 2-50 wt. %, preferably 3-35 wt. %, in particular 5-25 wt. %, based on the weight of the total composition.

In a further embodiment, the composition contains a chemical blowing agent H, as is available, for example, under the trade name Expancel™ from Akzo Nobel, or Celogen™ from Chemtura, or Luvopor™ from Lehmann & Voss, Germany. The proportion of such a blowing agent H is advantageously 0.1-3 wt.-%, based on the weight of the composition.

The composition advantageously contains in addition at least one reactive diluent G bearing epoxy groups. These reactive diluents G are in particular:
Glycidyl ethers of monofunctional saturated or unsaturated, branched or unbranched, cyclic or open-chain C₄-C₃₀ alcohols, e.g. butyl glycidyl ether, hexyl glycidyl ether, 2-ethylhexyl glycidyl ether, allyl glycidyl ether, tetrahydrofurfuryl and furfuryl glycidyl ether, trimethoxysilyl glycidyl ether etc.
Glycidyl ethers of difunctional saturated or unsaturated, branched or unbranched, cyclic or open-chain C₂-C₃₀ alcohols, e.g. ethylene glycol glycidyl ether, butanediol glycidyl ether, hexanediol glycidyl ether, octanediol glycidyl ether, cyclohexane dimethanol diglycidyl ether, neopentyl glycol diglycidyl ether etc.
Glycidyl ethers of trifunctional or polyfunctional, saturated or unsaturated, branched or unbranched, cyclic or open-chain alcohols such as epoxidized castor oil, epoxidized trimethylolpropane, epoxidized pentaerythrol, or polyglycidyl ethers of aliphatic polyols such as sorbitol, glycerol, trimethylolpropane, etc.
Glycidyl ethers of phenol compounds and aniline compounds such as phenyl glycidyl ether, cresyl glycidyl ether, p-tert-butylphenyl glycidyl ether, nonylphenyl glycidyl ether, 3-n-pentadecenyl glycidyl ether (from cashew nutshell oil), N,N-diglycidyl aniline, etc.
Epoxidized amines such as N,N-diglycidyl cyclohexylamine etc.
Epoxidized monocarboxylic acids or dicarboxylic acids such as neodecanoic acid glycidyl ester, methacrylic acid glycidyl ester, benzoic acid glycidyl ester, phthalic acid diglycidyl ester, tetra- and hexahydrophthalic acid diglycidyl ester, diglycidyl esters of dimeric fatty acids, etc.
Epoxidized difunctional or trifunctional, low molecular weight or high molecular weight polyether polyols such as polyethylene glycol diglycidyl ether, polypropylene glycol diglycidyl ether, etc.

Hexanediol diglycidyl ether, cresyl glycidyl ether, p-tert-butylphenyl glycidyl ether, polypropylene glycol diglycidyl ether, and polyethylene glycol diglycidyl ether are especially preferred.

The total proportion of reactive diluent G bearing epoxy groups is advantageously 0.1-20 wt. %, preferably 0.5-8 wt. %, based on the weight of the total composition.

The composition can include other components, in particular catalysts, heat and/or light stabilizers, thixotropic agents, plasticizers, solvents, mineral or organic fillers, dyes and pigments.

The one-component heat-curing epoxy resin composition at 25° C. preferably has a viscosity below 1000 Pa·s, in particular between 5 and 900 Pa·s, preferably between 150 and 800 Pa·s, so the composition can be easily applied at room temperature. The viscosities given in this document were measured on a rheometer (CVO 120 HR, Bohlin) by means of oscillographic measurements (gap: 1000 μm, plate/plate, plate diameter: 25 mm, frequency: 5 Hz, target strain: 0.01) in a temperature range of 23° C.-70° C. (heating rate: 10° C./min).

It was shown that the heat-curing epoxy resin compositions according to the invention can be used especially as one-component adhesives.

Therefore the invention relates in a further aspect to application of the one-component heat-curing epoxy resin composition described above as a one-component heat-curing adhesive, in particular as a heat-curing one-component bodyshell adhesive in automotive assembly. In particular, it was shown that the heat-curing epoxy resin compositions, after heating at a temperature of 100° C. to 130° C., in particular 115° C. to 125° C., have very good wash resistance.

Especially when using tougheners D, as described in detail above, adhesives can be realized which after curing are distinguished by high impact strength. Such adhesives are needed for bonding heat-stable materials. “Heat-stable materials” means materials which for a cure temperature of 140° C.-220° C., preferably 140° C.-200° C., are shape-stable at least during the cure time. Here the heat-stable materials in particular are metals and plastics such as ABS, polyamide, polyphenylene ethers, composite materials such as SMC, glass fiber reinforced unsaturated polyesters, epoxy or acrylate composites. A preferred use is when at least one material is a metal. An especially preferred use is bonding of identical or different metals, in particular in bodyshells in the automobile industry. Preferred metals are especially steel, in particular electrogalvanized steel, hot-dip galvanized steel, lubricated steel, Bonazinc-coated steel, and subsequently phosphatized steel as well as aluminum, in particular the types commonly used in automobile construction, and CDC-coated metals (CDC=cathodic dip coating), in particular CDC-coated steel.

A further aspect of the invention thus relates to a method for bonding heat-stable substrates, including the following steps:

i) Application of a one-component heat-curing epoxy resin composition, as described above, to the surface of a heat-stable substrate S1, in particular a metal;

ii) Bringing the applied heat-curing epoxy resin composition into contact with the surface of another heat-stable substrate S2, in particular a metal;

iii) Heating the epoxy resin composition to a temperature of 100° C. to 130° C., preferably 115° C. to 125° C.;

iv) Bringing substrates S1 and S2, and the heat-curing epoxy resin composition in contact with them, into contact with a wash liquid at a temperature between 20° C. and 100° C., in particular between 40° C. and 70° C.; preferably between 50° C. and 70° C.

v) Heating the composition to a temperature of 140° C.-220° C., in particular 140° C.-200° C., preferably between 160° C. and 190° C.

Substrate S2 here consists of material which is the same as or different from substrate S1.

The heat-stable substrate S1 and/or S2 in particular are metals and plastics such as ABS, polyamide, polyphenylene ethers, composite materials such as SMC, glass fiber reinforced unsaturated polyesters, epoxy or acrylate composites. A preferred use is when at least one material is a metal. A particularly preferred use is bonding of identical or different metals, in particular in bodyshells in the automobile industry. Preferred metals are especially steel, in particular electrogalvanized steel, hot-dip galvanized steel, lubricated steel, Bonazinc-coated steel, and subsequently phosphatized steel as well as aluminum, in particular the types commonly used in automobile construction, and CDC-coated metals, in particular CDC-coated steel.

Thus preferably substrate S1 and/or substrate S2 is a metal coated prior to step i) by cathodic dip coating (CDC).

Step iii) typically is carried out by running the joined part resulting from step ii) through a continuous furnace, in particular using a conveyor belt.

Step iv) typically is carried out by spray washing using a wash fluid or by dipping in a wash bath. This washing process is typically carried out at a temperature of 60° C. Water is used in particular as the wash liquid. Furthermore, the wash liquid can contain other components, in particular surfactants and/or solvents. Spray washing is done repeatedly at rather high pressure. Pressures up to 4 bar are quite normal.

Such a method for bonding heat-stable materials results in a bonded article, which represents a further aspect of the present invention. Such an article is preferably a vehicle or part of a vehicle, in particular a mounted part on a vehicle.

Of course, in addition to heat-curing adhesives, sealants or coatings can also be realized with a composition according to the invention. Furthermore, the compositions according to the invention are not only suitable for automobile construction but are also suitable for other areas of application. We should especially mention related applications in construction of means of transportation such as ships, trucks, buses, or track vehicles, or in construction of consumer goods such as, for example, washing machines.

It was shown that the epoxy resin compositions at 25° C. (η_{25°}) in fact have low viscosity, in particular below 1000 Pa·s, so application at room temperature is made possible, but after brief heating of the applied composition at a temperature of 100° C. to 130° C., they show a considerable rise in viscosity. The duration of the brief heating is typically 5 to 15 minutes. The rise in viscosity is such that at 60° C., the measured viscosity after heating)(η_{Δ,60°}) is above 200 Pa·s. The ratio of the viscosities measured at 60° C. for the composition after (η_{Δ,60°}) and before (η_{60°}) heating at 100° C.-130° C. is a value η_{Δ,60°}/η_{60°}>6, in particular >9.

The fact that the viscosities measured at 60° C. for the corresponding compositions without the amine AM undergo no increase or only a small increase as a result of heating at 100° C.-130° C., i.e., the η_{Δ,60°}/η_{60°} ratio is <4, in particular <3, shows that the epoxy groups are still uncrosslinked or almost uncrosslinked from brief heating. The fact that this desirable rise in viscosity occurs for the compositions according to the invention, leading to improved wash resistance, is quite surprising.

Furthermore, the “yield point” measured at 60° C. for these compositions after brief heating at 100° C.-130° C. is preferably above 40 Pa, in particular above 50 Pa.

The yield points given in this document were determined using a rheometer (CVO 120 HR, Bohlin) by means of isothermal measurements at 60° C. after pre-shearing (plate/plate, gap: 1000 μm, plate diameter: 25 mm, shear rate 10 s⁻¹, 30 s). The yield limit is the shear stress at which the measured viscosity exceeds the threshold value of 500 000 Pa·s, where the applied shear stress of 1000 Pa is gradually lowered to 10 Pa (delay time 10 s, integration time 15 s, 30 measurement points logarithmically distributed on the stress axis).

The low viscosity of the compositions firstly permits application of the composition at room temperature, and secondly the application is considerably simplified. Thus the compositions can be applied repeatedly at room temperature by a spray method. Other application methods are likewise conceivable, sometimes without heating (i.e., at room temperature), such as swirl application, flat-stream, mini flat-stream, and fine jet spraying at velocities of >200 mm/s, or the like.

Thus arises a considerable advantage in application, namely omitting the step of heating the composition before application, which in particular also leads to less contamination and clogging of the application device (in particular nozzles or rotating parts).

It was furthermore shown that the compositions have excellent storage stability.

It was quite surprisingly shown that an amide AM, as described in detail above, can be used to improve the wash resistance of a bodyshell adhesive in automotive assembly.

### EXAMPLES

### Compositions

The following compositions were prepared as specified in Table 1.

In Example 2, the liquid epoxy resin and the solid epoxy resin proportion was reduced in order to increase the proportion of a terminated polyurethane polymer toughener D-1, which was prepared as follows:

150 g Poly-THF 2000 (BASF, OH value 57 mg/g KOH) and 150 Liquiflex H (Krahn (hydroxyl-terminated polybutadiene), OH value 46 mg/g KOH) were dried for 30 minutes under vacuum at 105° C. After the temperature had been lowered to 90° C., 61.5 g IPDI (isophorone diisocyanate, Evonik) and 0.14 g dibutyltin dilaurate were added. The reaction was carried out under vacuum at 90° C. until the NCO content was constant at 3.10%, after 2.0 h (calculated NCO content: 3.15%). Then 96.1 g cardanol (Cardolite NC-700, Cardolite) was added as a blocking agent. Stirring was continued at 105° C. under vacuum until the NCO content dropped below 0.2%, after 3.5 h. The product was then used as toughener D-1.

In Example Ref. 4, 6 parts by weight of pyrogenic silicic acid were used in order to achieve a viscosity (η_{Δ,60°}) at 60° C. after heating that was comparable with Examples 1 to 3. However, when 3 parts by weight Aerosil® were similarly added (not given in the table), (η_{Δ,60°}) was much lower and the yield point at 60° C. was below 10 Pa.

### Test Methods

### Viscosity

The viscosities were measured on a rheometer (CVO 120 HR, Bohlin) by means of oscillographic measurements (gap: 1000 μm, plate/plate, plate diameter: 25 mm, frequency: 5 Hz, target strain: 0.01) in a temperature range of 23° C.-70° C. (heating rate: 10° C./min). The viscosities before heating are given as η, respectively η_{25°} or η_{60°}; the viscosities after 12 minutes of heating at 125° C. are given as η_{Δ}, respectively η_{Δ,25°} or η_{Δ,60°}.

### Yield Points

The yield points were determined on a rheometer (CVO 120 HR, Bohlin) by means of isothermal measurements at 60° C. after pre-shearing (plate/plate, gap: 1000 μm, plate diameter: 25 mm, shear rate 10 s⁻¹, 30 s). The yield limit is the shear stress at which the measured viscosity exceeds the threshold value of 500 000 Pa·s, where the applied shear stress of 1000 Pa is gradually lowered to 10 Pa (delay time 10 s, integration time 15 s, 30 measurement points logarithmically distributed on the stress axis).

### Wash Resistance

In order to determine the wash resistance, the respective composition was applied at room temperature as a round bead to a lubricated sheet (hot-dip galvanized). Then the test piece was heated in an oven at 125° C. for 12 minutes, and cooled down again to room temperature. Then this sheet was mounted on a bogie and was spray washed with a warm water jet (60° C.) at 3 bar water pressure for 10 minutes while the sheet was rotated (20 rpm). The test pieces for which adhesion was not lost or was only slightly lost (less than 50% of the bonding surface area) were designated as wash-resistant (“OK”).

The test pieces for which adhesion was entirely lost or considerably lost (more than 50% of the bonding surface area) were designated as not wash-resistant (“not OK” or NOK))

TABLE 1

| | Ref. 1 | Ref. 2 | Ref. 3 | 1 | 2 | 3 | Ref. 4 |
|---|---|---|---|---|---|---|---|
| DGEBA [PBW¹] | 64 | 64 | 64 | 64 | 56 | 64 | 64 |
| D.E.R. ™ 671² [PBW¹] | 12 | 12 | 12 | 12 | | 12 | 12 |
| D-1 [PBW¹] | | | | | 20 | | |
| Dicy³ [PBW¹] | 5.7 | 5.7 | 5.7 | 5.7 | 5.7 | 5.7 | 5.7 |
| Accelerator⁴ [PBW¹] | 0.3 | 0.3 | 0.3 | 0.3 | 0.3 | 0.3 | 0.3 |
| Aerosil ® R202⁵ [PBW¹] | 3.0 | 3.0 | 3.0 | 3.0 | 3.0 | 3.0 | 3.0 |
| Chalk/calcium oxide mix [PBW¹] | 15.0 | 15.0 | 15.0 | 15.0 | 15.0 | 15.0 | 15.0 |
| Mowital ® B 60 H⁶ [PBW¹] | | 3 | | | | | |
| Zeon F351⁷ [PBW¹] | | | 3 | | | | |
| Luvotix ® HT⁸ [PBW¹] | | | | 3 | 3 | | |
| Disparlon ® 6200⁹ [PBW¹] | | | | | | 3 | |
| Aerosil ® R202⁵ [PBW¹] | | | | | | | 6 |
| η_{25°} [Pa · s] | 210 | 250 | 270 | 270 | 270 | 270 | 2200 |
| η_{60°} [Pa · s] | 10 | 30 | 10 | 10 | 30 | 40 | 1180 |
| η_{Δ, 25°} [Pa · s] | 510 | 2250 | 1310 | 1790 | 3270 | 1120 | 2500 |
| η_{Δ60°} [Pa · s] | 25 | 95 | 40 | 300 | 730 | 260 | 450 |
| η_{Δ, 60°}/η_{60°} | 2.5 | 3.2 | 4.0 | 30.0 | 24.0 | 6.5 | 0.4 |
| Yield point (60° C.) [Pa] | <10 | <10 | <10 | 60 | 136 | 55 | <10 |
| Wash resistance | NOK | NOK | NOK | OK | OK | OK | NOK |

Compositions and their results:
¹PBW = parts by weight,
²D.E.R. ™ 671, Dow, solid epoxy resin,
³dicyanodiamide,
⁴substituted urea accelerator
⁵Degussa, pyrogenic silicic acid,
⁶Kuraray Specialties, polyvinyl butyral,
⁷Zeon Europe, or Ganz Chemical Co. Ltd. Japan, acrylic core/shell polymer,
⁸Lehmann & Voss & Co., polyamide,
⁹Kusumoto Chemicals Ltd., polyamide wax.

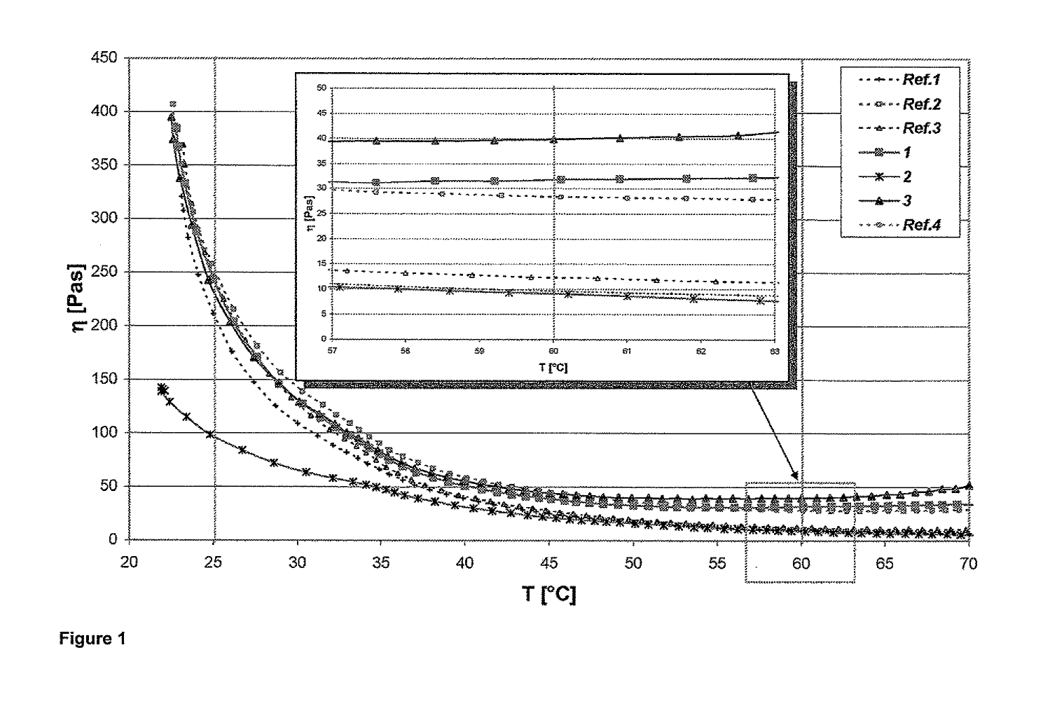

FIG. 1 shows in detail the measured viscosity curves (η vs. temperature) before heating at 125° C. For better visualization, the region between 57° C. and 63° C. is magnified as an insert in FIG. 1. The values for Ref. 4 are no longer visible because of the high values for the selected axes on the graph selected here in FIG. 1 (see η₂₅ and η₆₀ in Table 1).

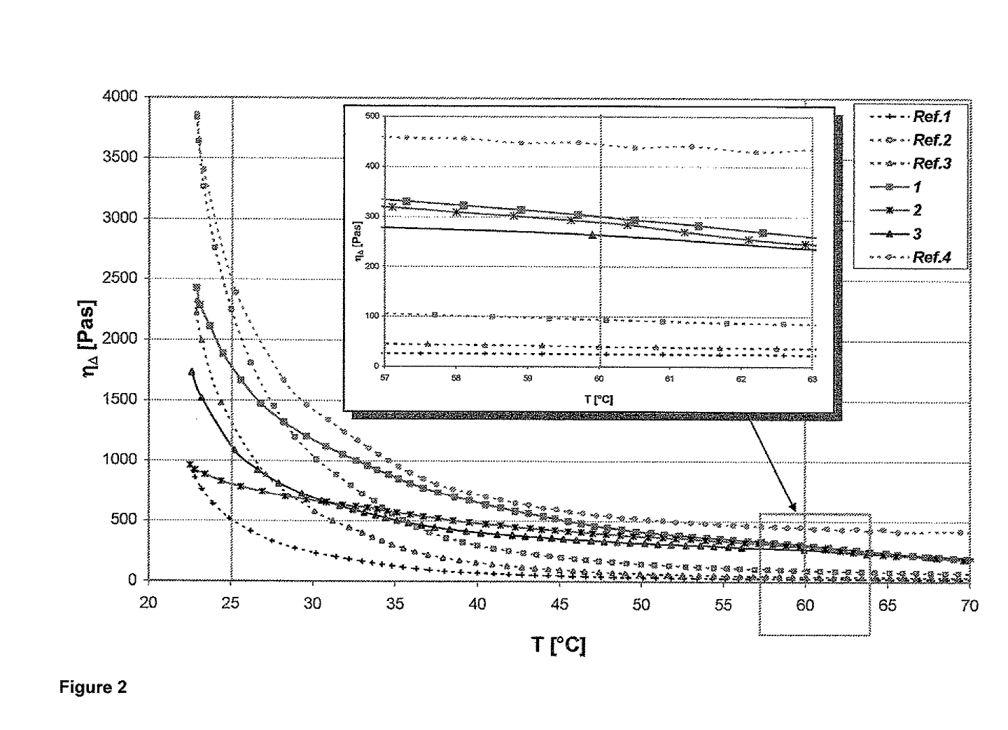

FIG. 2 shows in detail the measured viscosity curves (η_{Δ} vs. temperature) after 12 minutes of heating at 125° C. For better visualization, the region between 57° C. and 63° C. is magnified as an insert in FIG. 2.

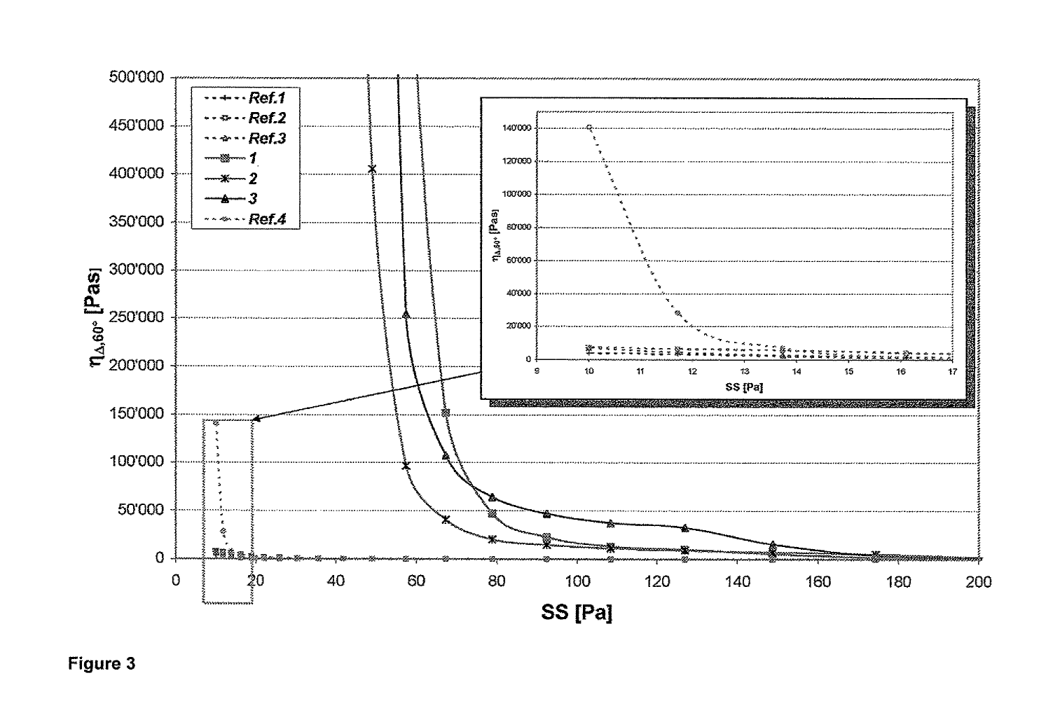

FIG. 3 shows in detail the measured curves for determination of the yield point (viscosity η_{Δ,60°} vs. shear stress (“SS”)) after 12 minutes of heating at 125° C. For better visualization, the region between 17 Pa and 9 Pa shear stress is magnified as an insert in FIG. 3.

1. One-component heat-curing epoxy resin composition comprising:
at least one epoxy resin A with more than one epoxy group per molecule on the average;
at least one curing agent B for epoxy resins, which is activated by elevated temperature; and
at least one amide AM with melting point from 100° C. to 145° C., where the amide AM is a fatty acid amide or a polyamide.

2. One-component heat-curing epoxy resin composition as in claim 1, wherein the amide AM has a melting point from 120° C. to 130° C.

3. One-component heat-curing epoxy resin composition as in claim 1, wherein the epoxy resin composition contains at least one toughener D.

4. One-component heat-curing epoxy resin composition as in claim 3, wherein the toughener D is selected from the group consisting of blocked polyurethane polymers, liquid rubbers, epoxy resin-modified liquid rubbers, and core/shell polymers.

5. One-component heat-curing epoxy resin composition as in claim 4, wherein the toughener D is a liquid rubber which is an acrylonitrile/butadiene copolymer, which is terminated by carboxyl groups or (meth)acrylate groups or epoxy groups, or is a derivative thereof.

6. One-component heat-curing epoxy resin composition as in claim 4, wherein the toughener D is a blocked polyurethane polymer of formula (I): 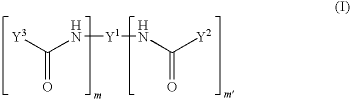
wherein
Y¹ stands for a linear or branched polyurethane polymer PU1 terminated by m+m′ isocyanate groups, after removal of all terminal isocyanate groups;
Y² each independently stands for a blocking group which is cleaved at a temperature above 100° C.;
Y³ each independently stands for a group of formula (I′): 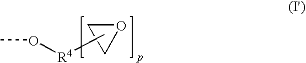
wherein R⁴ stands for an aliphatic, cycloaliphatic, aromatic, or araliphatic epoxy radical containing a primary or secondary hydroxyl group, after removal of the hydroxy and epoxy groups;
p=1, 2, or 3, and
m and m′ each stand for numbers between 0 and 8, provided that m+m′stands for a number from 2 to 8.

7. One-component heat-curing epoxy resin composition as in claim 6, wherein Y² stands for a radical selected from the group consisting of 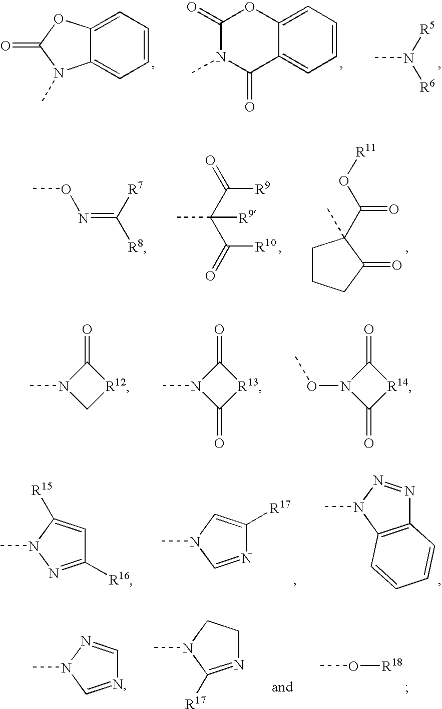
wherein
R⁵, R⁶, R⁷ and R⁸ each independently stands for an alkyl or cycloalkyl or aryl or aralkyl or arylalkyl group
or R⁵ together with R⁶ or R⁷ together with R⁸ form a part of a 4- to 7-membered ring, which is optionally substituted;
R⁹, R^{9′}, and R¹⁰ each independently stands for an alkyl or aralkyl or aryl or arylalkyl group or for an alkyloxy or aryloxy or aralkyloxy group;
R¹¹ stands for an alkyl group;
R¹², R¹³, and R¹⁴ each independently stand for an alkylene group with 2 to 5 C atoms, which optionally has double bonds or is substituted, or for a phenylene group or for a hydrogenated phenylene group;
R¹⁵, R¹⁶, and R¹⁷ each independently stand for H or for an alkyl group or for an aryl group or an aralkyl group; and
R¹⁸ stands for an aralkyl group or for a mononuclear or polynuclear substituted or unsubstituted aromatic group, which optionally has aromatic hydroxyl groups.

8. One-component heat-curing epoxy resin composition as in claim 6, wherein m is different from 0.

9. One-component heat-curing epoxy resin composition as in claim 1, wherein the proportion by weight of all amides AM in the composition is 0.1-5.0 wt. %.

10. One-component heat-curing epoxy resin composition as in claim 1, wherein the one-component heat-curing epoxy resin composition has a viscosity at 25° C. below 1000 Pa·s.

11. Method for bonding heat-stable substrates, comprising:
i) Application of a one-component heat-curing epoxy resin composition as in claim 1 to the surface of a heat-stable substrate S1;
ii) Bringing the applied heat-curing epoxy resin composition into contact with the surface of another heat-stable substrate S2;
iii) Heating the epoxy resin composition to a temperature of 100° C. to 130° C.;
iv) Bringing substrates S1 and S2, and the heat-curing epoxy resin composition in contact with them, into contact with a wash liquid at a temperature between 20° C. and 100° C.; and
v) Heating the composition to a temperature of 140° C.-220° C.;
wherein substrate S2 consists of material which is the same as or different from substrate S1.

12. Method as in claim 11, wherein substrate S1 and/or substrate S2 is a metal which has been coated by cathodic dip coating (CDC) before step i).

13. A heat-curing one-component bodyshell adhesive in automotive assembly comprising a one-component heat-curing epoxy resin composition as in claim 1.

14. Bonded article obtained by a method as in claim 11.

15. (canceled)
